(19) United States
(12) Patent Application Publication
(10) Pub. No.: US 2008/0190253 A1
(43) Pub. Date: Aug. 14, 2008

(54) Ergonomic plasma spray gun tool

(75) Inventor: George H. Reynolds, Sanford, CT (US)

Correspondence Address: David R. Fairbairn;Kinney & Lange, P.A., THE KINNEY & LANGE BUILDING, 312 South Third Street, Minneapolis, MN, 55415-1002, US

(73) Assignee: United Technologies Corporation, Hartford, CT (US)

(21) Appl. No.: 11/704,661

(22) Filed: Feb. 9, 2007

(51) Int. Cl. B25B 23/16

(52) U.S. Cl. 81/461; 29/428

(57) ABSTRACT

A tool for assembling and disassembling a plasma spray gun comprises a first removal and installation head, including a body, a drive socket and first and second prongs, which are spaced to mate with corresponding sockets disposed in a first plasma spray gun component, such as a cathode holder. In addition, the tool may comprise a second removal and installation head, including a body and first and second prongs, which are spaced to mate with corresponding sockets disposed in a second plasma spray gun component, such as a locking ring. The second removal and installation head is configured to attach to the first removal and installation head. The tool is ergonomically designed and easily allows the removal and/or installation of plasma spray gun components.

### BACKGROUND OF THE INVENTION

The present invention relates to a tool for assembling and disassembling a plasma spray gun. More specifically, the present invention relates to an ergonomic tool, which easily and comfortably removes and/or installs plasma spray gun components.

Gas turbine engine components are exposed to extreme temperatures and pressures during the course of operation. Therefore, coatings are typically applied to gas turbine engine components in order to protect the underlying component from degradation and wear. Conventional spray technology for applying the coatings typically utilizes standard plasma spray guns, such as the Sulzer-Metco 3 MB or a similar design. The materials which comprise the coating composition are rapidly heated in the plasma flame and accelerated at a high velocity onto the engine component, such that the heated composition adheres to the component's surface and forms the coating.

Conventional plasma spray guns are basically formed of an electrically conductive rear gun component, a front gun component and an electrical insulator sandwiched between the front and rear gun components. Due to the design of conventional plasma spray gun mounting hardware, removal and installation of plasma gun components is difficult. In an effort to access the closely spaced components, current plasma gun wrench designs do not offer superior mechanical advantage. Also, the removal problem is further exacerbated when the plasma gun components are overtightened during assembly. Since the configuration of the plasma spray gun prevents current wrench designs from providing enough torque to remove overtightened components, a hammer must sometimes be used to apply additional force to the handle of the wrench to achieve removal. Use of a hammer is undesirable because the force applied can damage both the wrench and the plasma spray gun components themselves.

Therefore, there is a need in the art for an ergonomically designed plasma spray gun tool, which allows for plasma spray gun components to be easily and efficiently removed.

### BRIEF SUMMARY OF THE INVENTION

The present invention is tool for assembling and disassembling a plasma spray gun. The tool comprises a first removal and installation head, including a body, a drive socket and first and second prongs, which are spaced to mate with corresponding sockets disposed in a first plasma spray gun component, such as a cathode holder. In addition, the tool may comprise a second removal and installation head, including a body and first and second prongs, which are spaced to mate with corresponding sockets disposed in a second plasma spray gun component, such as a locking ring. The second removal and installation head is configured to attach to the first removal and installation head. The tool is ergonomically designed and easily allows the removal and/or installation of plasma spray gun components.

### BRIEF DESCRIPTION OF THE DRAWINGS

FIG. 1 is a perspective side view of a first removal and installation head configured for use with a rear component of a plasma spray gun.

FIG. 2 is a perspective front view of a second removal and installation head configured for use with a front component of a plasma spray gun.

FIG. 3 is a perspective view of the second removal and installation head positioned for attachment to the first removal and installation head.

FIG. 4 illustrates the first removal and installation head coupled to a wrench and positioned to mate with a cathode holder.

FIG. 5 illustrates the second removal and installation head attached to the first removal and installation head and positioned to mate with a locking ring.

### DETAILED DESCRIPTION

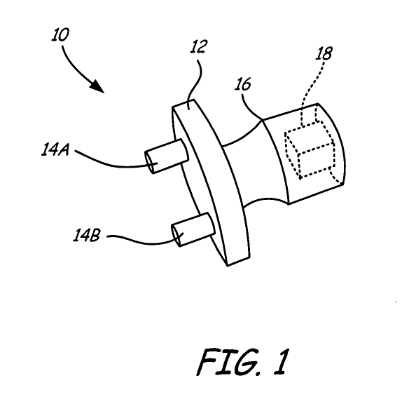

FIG. 1 is a perspective side view of first removal and installation head 10, which is configured for use with a rear component of a plasma spray gun. First removal and installation head 10 includes body 12, first and second prongs 14A and 14B, and drive socket 16. First and second prongs 14A-14B extend outward from a distal surface of body 12. Drive socket 16 is attached to a proximal surface of body 12 and includes recess 18.

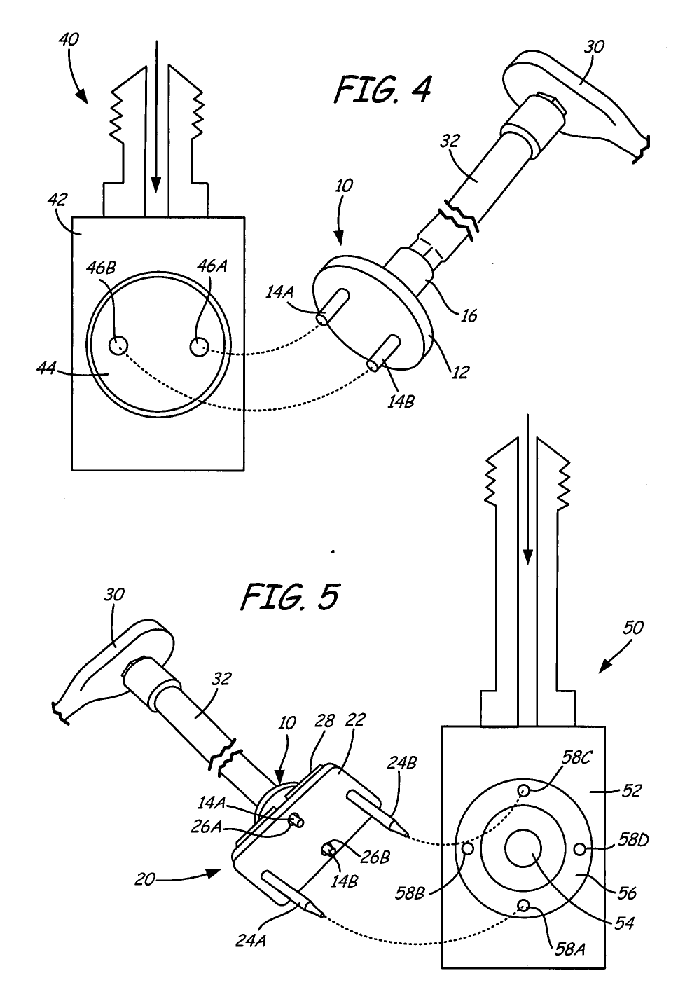

As shown in FIG. 1, first removal and installation head 10 is specifically configured for compatibility with a cathode holder located on the rear component of a conventional plasma spray gun, such as the Sulzer-Metco 3 MB or a similar design. (Use of first removal and installation head 10 in conjunction with a cathode holder is described in detail with respect to FIG. 4.) However, the invention is not so limited and first removal and installation head 10 may be configured for use with another plasma spray gun component.

In an exemplary embodiment, body 12 of first removal and installation head 10 is generally circular and has a diameter of about 1.250 inches (3.175 centimeters). Drive socket 16 is integrally formed with or welded onto the center of the proximal surface of body 12. Drive socket 16 is a standard ⅜ inch drive socket and includes square recess 18 at one end, which allows drive socket 16 to couple with a wrench (as described in detail with respect to FIG. 4). In an exemplary embodiment, prongs 14A and 14B are about 0.3 inches (0.762 centimeters) in length and about 0.190 inches (0.483 centimeters) in diameter. Prongs 14A and 14B extend from the distal surface of body 12 and are positioned along a center line extending across the diameter of body 12. Prongs 14A and 14B are spaced about 0.650 inches (1.65 centimeters) apart. However, it should be understood that the dimensions of first removal and installation head 10 may vary depending on the configuration of the corresponding plasma spray gun component. For instance, in an exemplary embodiment, the length of prongs 14A and 14B could range from about 0.1 inches (0.254 centimeters) to about 0.5 inches (1.27 centimeters) and the distance between prongs 14A and 14B could range from about 0.25 inches (0.635 centimeters) to about 1 inch (2.54 centimeters).

First removal and installation head 10 may be comprised of a metal, such as carbon steel or any other suitable material. In addition, first removal and installation head 10 may be formed of individual parts, which are welded together or first removal and installation head 10 may also be formed, for example, of a single unitary piece of molded or forged metal.

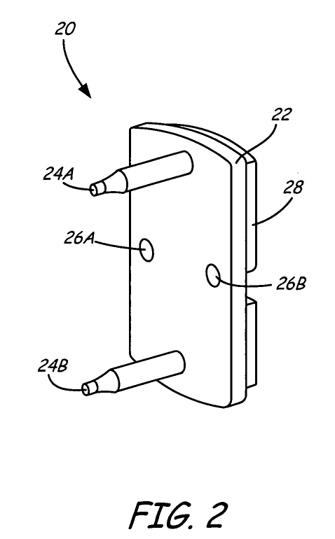

FIG. 2 is a perspective side view of second removal and installation head 20, which is configured for use with a front component of a plasma spray gun. Second removal and installation head 20 includes body 22, first and second prongs 24A and 24B, attachment holes 26A and 26B and magnetic layer 28. First and second prongs 24A-24B extend outward from a distal surface of body 22. Attachment holes 26A and 26B extend through body 22. Magnetic layer is attached to a proximal surface of body 22.

As shown in FIG. 2, second removal and installation head 20 is specifically configured for compatibility with a linking ring located on the front component of conventional plasma spray gun, such as the Sulzer-Metco 3 MB or a similar design. (Use of second removal and installation head 20 in conjunction with a linking ring is described in detail with respect to FIG. 5.) However, the invention is not so limited and second removal and installation head 20 may be configured for use with another plasma spray gun component.

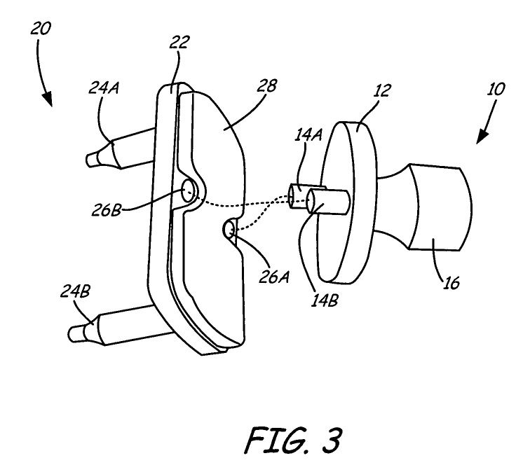

In an exemplary embodiment, body 22 of second removal and installation head 20 is generally rectangular and has a length of about 1.90 inches (4.826 centimeters) and a width of about 1.250 inches (3.175 centimeters). Attachment holes 26A and 26B are positioned though a center line extending across the width of body 22 and are spaced about 0.650 inches (1.65 centimeters) apart. (The function of attachment holes 26A and 26B will be described in detail with respect to FIG. 3). Also, in an exemplary embodiment, prongs 24A and 24B are about 0.80 inches (2.032 centimeters) in length and about 0.190 inches (0.483 centimeters) in diameter with an outer tip having a diameter of about 0.120 inches (0.301 centimeters). Prongs 24A and 24B extend from the distal surface of body 22 and are positioned through a center line extending across the length of body 22. Prongs 24A and 24B are spaced about 1.25 inches (3.175 centimeters) apart. However, it should be understood that the dimensions of second removal and installation head 20 may vary depending on the configuration of the corresponding plasma spray gun component. For instance, in an exemplary embodiment, the length of prongs 24A and 24B could range from about 0.5 inches (1.27 centimeters) to about 1 inch (2.54 centimeters) and the distance between prongs 24A and 24B could range from about 0.75 inches (1.905 centimeters) to about 1.5 inches (3.81 centimeters).

Second removal and installation head 20 may be comprised of a metal, such as carbon steel or any other suitable material. In addition, second removal and installation head 20 may be formed of individual parts, which are welded together. In addition, second removal and installation head 20 may also be formed, for example, of a single unitary piece of molded or forged metal.

FIG. 3 is a perspective view of the second removal and installation head 20 positioned for attachment to first removal and installation head 10. As described with reference to FIG. 1, first removal and installation head 10 includes drive socket 16 attached to the proximal surface, which allows drive socket 16 to couple with a wrench (as described in detail with respect to FIG. 4). While first removal and installation head 10 has the ability to couple with a wrench, second removal and installation head 20 has the ability to couple with first removal and installation head 10.

As shown in FIG. 3, attachment holes 26A and 26B extend though body 22 of second removal and installation head 20 and are spaced to receive prongs 14A and 14B of first removal and installation head 10. As a result, prongs 14A and 14B may be inserted into attachment holes 26A and 26B, which brings the distal surface of first removal and installation head 10 flush with the proximal surface of second removal and installation head 20, essentially holding first removal and installation head 10 and second removal and installation head 20 in position against each other. In addition, since first removal and installation head 10 is formed of a metal, magnetic layer 28, which is attached to the proximal surface of second removal and installation head 20, securely adheres to the distal surface of first removal and installation head 10. However, the invention is not so limited and second removal and installation head 20 may be attached to first removal and installation head 10 with any suitable method. Once attached, second removal and installation head 20 is positioned so that prongs 24A and 24B extend outward. Therefore, second removal and installation head 20 can be utilized as described with reference to FIG. 5.

FIG. 4 illustrates first removal and installation head 10 in use. Wrench 30 is shown coupled to wrench extender 32. Also shown is rear gun component 40, which includes cathode 42, cathode holder 44 and cavities 46A and 46B.

Wrench 30, which is a standard ⅜-drive ratchet wrench, is coupled to wrench extender 32. Wrench 30 includes a ratcheting mechanism, which allows a component to be tightened or loosened with a continuous motion. This eliminates the user from having to remove wrench 30 and refit it after each turn. The design of wrench 30 also provides enough torque to remove overtightened components, which eliminates excessive force being applied to the tool. Since removal and installation of plasma gun components is difficult due to the design of conventional plasma spray gun mounting hardware, wrench extender 32 is coupled to wrench 30, which enables access to difficult to reach components. First removal and installation head 10 is attached to wrench extender 32 by inserting the tip of wrench extender 32 into recess 18 inside drive socket 16.

In an exemplary embodiment, first removal and installation head 10 is configured to disassemble and/or assemble rear gun component 40, which includes cathode 42 and cathode holder 44. Cavities 46A and 46B are positioned in the center of cathode holder 44 and, upon engagement, allow cathode holder 44 to be removed and/or installed. Prongs 14A and 14B extend outward from first removal and installation head 10 and are configured to mate with cavities 46A and 46B, respectively. As indicated in FIG. 4 by dashed lines, first removal and installation head 10 is engaged with cathode holder 44 by inserting prongs 14A and 14B into cavities 46A and 46B. Upon insertion of prongs 14A and 14B, body 12 of first removal and installation head 10 fits securely against cathode holder 44. Wrench 30 can then be used to rotate cathode holder 44 in a clockwise direction if installation is desired or in a counterclockwise direction if removal is desired. The handle of wrench 30 is comfortable for the user to grasp and offers superior mechanical advantage. Once cathode holder 44 is properly installed or removed, first removal and installation head 10 may be disengaged from cathode holder 44.

FIG. 5 illustrates second removal and installation head 20 in use. Wrench 30 is shown coupled to wrench extender 32 and first removal and installation head 10 is shown coupled to wrench extender 32, as described with reference to FIG. 4. In addition, second removal and installation head 20 is shown attached to first removal and installation head 10, as described with reference to FIG. 3. Also shown is front gun component 50, which includes front gun body 52, nozzle 54, locking ring 56 and cavities 58A-58D.

In an exemplary embodiment, second removal and installation head 20 is configured to disassemble and/or assemble front gun component 50, which includes front gun body 52, nozzle 54 and locking ring 56. Cavities 58A-58D are positioned evenly around locking ring 56, which surrounds nozzle 54, and upon engagement allow locking ring 56 to be removed and/or installed. Prongs 24A and 24B extending from first removal and installation head 10 are configured to mate with cavities 58A and 58C or cavities 58B and 58D, respectively. As indicated in FIG. 5 by dashed lines, second removal and installation head 20 may be engaged with locking ring 56 by inserting prongs 24A and 24B into cavities 58A and 58C. (Second removal and installation head 20 may also be engaged with locking ring 56 by inserting prongs 24A and 24B into cavities 58B and 58D.) Upon insertion of prongs 24A and 24B, body 22 of second removal and installation head 20 fits securely against locking ring 56. Wrench 30 can then be used to rotate locking ring 56 in a clockwise direction if installation is desired or in a counterclockwise direction if removal is desired. Once locking ring 56 is properly installed or removed, second removal and installation head 20 may be disengaged from locking ring 56.

Although the present invention has been described with reference to preferred embodiments, workers skilled in the art will recognize that changes may be made in form and detail without departing from the spirit and scope of the invention.

1. An ergonomic tool configured to assemble and disassemble a plasma spray gun, the tool comprising:
a first body having a proximal surface and a distal surface, the distal surface including first and second prongs extending outward and spaced to mate with corresponding sockets disposed in a first plasma spray gun component;
a drive socket attached to the proximal surface of the first body;
a second body having a proximal surface and a distal surface, the distal surface including first and second prongs extending outward and spaced to mate with corresponding sockets disposed in a second plasma spray gun component;
first and second holes extending through the proximal and distal surfaces of the second body spaced to receive the first and second prongs of the first body; and
a magnetic layer attached to the proximal surface of the second body for removably securing the distal surface of the first body to the proximal surface of the second body.

2. The tool of claim 1 wherein the first plasma spray gun component is a cathode holder.

3. The tool of claim 1 wherein the distance between the first and second prongs is about 0.25 inches to about 1 inch.

4. The tool of claim 1 wherein the length of the first and second prongs is about 0.1 inches to about 0.5 inches.

5. The tool of claim 1 wherein the drive socket enables the tool to couple with a wrench.

6. (canceled)

7. The tool of claim 1 wherein the second plasma spray gun component is a locking ring.

8. The tool of claim 1 wherein the distance between the first and second prongs extending from the second body is about 0.75 inches to about 1.5 inches.

9. The tool of claim 1 wherein the length of the first and second prongs extending from the second body is about 0.5 inches to about 1 inch.

10. (canceled)

11. The tool of claim 1 wherein the tool is comprised of a metal.

12. (canceled)

13. An ergonomic tool configured to assemble and disassemble a plasma spray gun, the tool comprising:
a wrench;
a wrench extender coupled to the wrench;
a first head having a proximal side and a distal side, wherein the proximal side is coupled to the wrench extender and the distal side comprises first and second prongs extending outward and insertable into corresponding sockets disposed in a first plasma spray gun component;
a second head having a proximal side and a distal side, wherein the proximal side is configured to abut to the first head and the distal side comprises first and second prongs extending outward and insertable into corresponding sockets disposed in a second plasma spray gun component;
first and second holes extending through the second head which are spaced to receive the first and second prongs extending from the distal surface of the first head when the second head is attached to the first head; and
a magnetic layer attached to the proximal side of the second head which adheres to the distal side of the first head when the second head is attached to the first head.

14. The tool of claim 13 wherein the first plasma spray gun component is a cathode holder.

15. (canceled)

16. The tool of claim 13 wherein the second plasma spray gun component is a locking ring.

17. (canceled)

18. The tool of claim 13 wherein the wrench is comprised of a metal.

19. (canceled)

20. A method of ergonomically assembling a plasma spray gun, the method comprising:
coupling a wrench extender to a wrench;
attaching a first head to the wrench extender by inserting an outer end of the wrench extender into a drive socket welded onto a proximal side of the first head;
inserting first and second prongs which extend from a distal side of the first head into corresponding sockets disposed in a cathode holder of a rear gun component; rotating the cathode holder in a clockwise direction;
disengaging the first head from the cathode holder;
attaching a second head to the first head by inserting the first and second prongs extending from a distal side of the first head into first and second holes extending though the second head and securely contacting a magnetic layer adhered to proximal side of the second body against the distal side of the first head;
inserting first and second prongs which extend from a distal side of the second head into corresponding sockets disposed in a locking ring of a front gun component;
rotating the locking ring in a clockwise direction; and
disengaging the second head from the locking ring.

21. (canceled)

22. (canceled)

23. A method of ergonomically dissembling a plasma spray gun, the method comprising:
coupling a wrench extender to a wrench;
attaching a first head to the wrench extender by inserting an outer end of the wrench extender into a drive socket welded onto a proximal side of the head;
inserting first and second prongs which extend from a distal side of the first head into corresponding sockets disposed in a cathode holder of a rear gun component;
rotating the cathode holder in a counterclockwise direction;
disengaging the first head from the cathode holder;
attaching a second head to the first head by inserting the first and second prongs extending from a distal side of the first head into first and second holes extending though the second head and securely contacting a magnetic layer adhered to a proximal side of the second body against the distal side of the first head;
inserting first and second prongs which extend from a distal side of the second head into corresponding sockets disposed in a locking ring of a front gun component;
rotating the locking ring in a counterclockwise direction; and
disengaging the second head from the locking ring.

24. (canceled)

25. (canceled)
